(19) United States
(12) Patent Application Publication
(10) Pub. No.: US 2017/0118822 A1
(43) Pub. Date: Apr. 27, 2017

(54) ILLUMINATED FOIL BALLOON WITH LIGHTS SYNCHRONIZED TO MUSIC

(71) Applicants: Kurt C. Kosted, Pflugerville, TX (US); Randy M. Kosted, Kalispell, MT (US); Phillip W. Kosted, Rusk, TX (US)

(72) Inventors: Kurt C. Kosted, Pflugerville, TX (US); Randy M. Kosted, Kalispell, MT (US); Phillip W. Kosted, Rusk, TX (US)

(21) Appl. No.: 15/345,913

(22) Filed: Nov. 8, 2016

Related U.S. Application Data
(63) Continuation of application No. 15/330,090, filed on Nov. 13, 2014.

(51) Int. Cl. H05B 37/02; F21V 33/00; F21L 4/02; A63H 27/10; F21V 7/22; G10K 9/125; G09F 21/10; F21V 23/04; F21V 23/00

(52) U.S. Cl. CPC H05B 37/0236; F21V 23/0414; F21V 33/008; F21L 4/02; F21V 23/003; F21V 7/22; G10K 9/125; G09F 21/10; A63H 27/10; F21Y 2115/10

(57) ABSTRACT

An illuminated inflatable balloon assembly having translucent graphics associated with the exterior of the balloon, a clear window extending through the balloon, a light source positioned between the clear window and a reflective material, a power source, a controller for controlling the illumination of the light source, and an on/off switch for controlling power to the light source. In one embodiment, the controller causes the light source to repeatedly flash when power is supplied thereto. In another embodiment, the controller is coupled to a sound generator and piezoelectric buzzer and is programmed to synchronize the illumination of the light source to musical sounds generated by the sound generator through the piezoelectric buzzer. In still another embodiment, the controller is coupled to a microphone and is programmed to synchronize the illumination of the light source to music received by the microphone from an external sound source.

### CROSS-REFERENCE TO RELATED APPLICATIONS

The present application is a continuation of co-pending application Ser. No. 15/330,090 filed Nov. 13, 2014, the entire disclosure of which is incorporated herein by reference.

### FIELD OF THE INVENTION

The present invention relates generally to illuminated inflatable balloons and, more particularly, to an illuminated inflatable foil balloon having at least one LED light, and preferably a plurality of LED lights, which are powered by a controller which causes the light(s) to blink or flash independently of each other. In another embodiment, the lights are synchronized to a sound generator and other components so that the lights will flash in sequence with musical sounds provided by the sound generator and other components. In still another embodiment, the controller includes a microphone which enables the lights to be synchronized with music coming from an external sound source.

### BACKGROUND OF THE INVENTION

Illuminating balloons through the use of lights externally affixed to the outside portion of a balloon is not new and dates back to at least the 1970s. See, for example, U.S. Pat. No. 3,672,083 entitled ‘Inflatable and Illuminable Figure’. Other lighted balloons include illuminated balloon assemblies as disclosed in U.S. Pat. No. 5,117,344 and U.S. Pat. No. 7,914,360. More particularly, U.S. Pat. No. 5,117,344 discloses an illuminated balloon assembly wherein an electric lamp is fixedly attached to the outer surface of the balloon so as to direct light through an interior chamber of the balloon effectively illuminating a translucent design printed on at least a portion of the balloon body. A power source is electrically interconnected with the electric lamp for energizing the lamp and may be attached to the exterior of the balloon in a combined unit with the electric lamp, or separately on the end of an interconnecting stick or cord connected to and extending from the neck portion of the balloon.

Still further, U.S. Pat. No. 7,914,360 discloses an illuminated balloon wherein a light is affixed to a patch and the patch is affixed to the outer surface of the inflated balloon such that the light is between the patch and the outer surface of the balloon. The light is positioned and structured so as to direct light into the interior chamber of the balloon so that it can exit at least partially out through the balloon body. The light source is mounted so as to press into the outer surface of the inflated balloon such that the pressing of the light into such outer surface produces a unique lighted balloon effect. More specifically, the outer surface of the balloon contacts and partially envelops the light source and produces a unique illuminated balloon effect that does not occur with either lights placed within an inflated balloon or lights placed on the outside of the inflated balloon. A tab is also associated with the light patch such that movement of the tab turns the light source on and off.

None of the known illuminated inflatable balloons include blinking or flashing lights and, more particularly, none of the known illuminated balloons include lights which are synchronized to music.

### SUMMARY OF THE INVENTION

The present invention is an inflatable balloon having graphics printed on the exterior surface of the balloon body with translucent ink, a light source, a controller programmed to control the light source, and a clear window for allowing the light source to enter the interior portion of the balloon. The exterior background colors associated with the exterior portion of the balloon body are printed with opaque inks that surround the translucent graphics and the interior of the balloon includes a standard interior reflective backing material. The balloon body includes a clear window over which at least one and, preferably, a plurality of LED lights are attached so that light generated by the LED lights can enter the interior portion of the balloon. The LED lights are attached to the balloon using an adhesive coated reflective material such that all of the light emitted by the LED lights is focused through the clear window to the interior of the balloon and is thereafter reflected by the reflective backing material associated with the interior of the balloon. As light bounces around within the interior portion of the balloon, it is allowed to escape through the translucent ink at which point the graphics become illuminated.

The LED lights are powered by at least one battery and a controller is programmed to cause the LED light, or plurality of lights, to blink and/or flash and, if multiple LED lights are used, the controller will cause the plurality of LED lights to turn on and off independently. In one embodiment, a sound generator and a piezoelectric buzzer are coupled to each other and to the controller to cause the blinking of the LED lights to be synchronized with musical sounds coming out of the piezoelectric buzzer. In still another embodiment, a microphone is likewise coupled to the controller so that the blinking of the LED lights can be synchronized with music coming from an external sound source. A small on/off switch is also incorporated into the present balloon to turn the LED lights, the controller and other components off when not in use.

Other aspects and advantages of the present invention will be apparent from the following detailed description of the various embodiments and the accompanying drawings.

### BRIEF DESCRIPTION OF THE DRAWINGS

For better understanding of the various embodiments of the present invention, reference may be made to the accompanying drawings in which:

FIG. 1 is a front elevational view of an inflatable foil balloon constructed in accordance with the teachings of the present invention having opaque and translucent ink as well as a clear window associated with the foil balloon.

FIG. 2 is a partial front elevational view of FIG. 1 illustrating one embodiment of the present invention wherein a single LED light source and its associated electrical connections are positioned over the clear window associated with the present balloon.

FIG. 3 is a partial front elevational view of FIG. 1 illustrating another embodiment of the present invention wherein a plurality of LED lights are positioned over the clear window of the present balloon, the lights being electrically coupled to a controller, a sound generator and a piezoelectric buzzer.

FIG. 4 is a partial front elevational view of FIG. 1 illustrating still another embodiment of the present invention wherein a plurality of LED lights are positioned over the clear window of the present balloon, the LED lights being coupled to a controller, and including a microphone for synchronizing the LED lights to an external sound source.

### DETAILED DESCRIPTION OF THE INVENTION

The present invention will be described in relationship to the drawing figures in which like reference numerals refer to like parts. For purposes of clarity in illustrating the various features and characteristics of the present invention, proportional relationship of the various elements have not necessarily been maintained throughout the drawing figures.

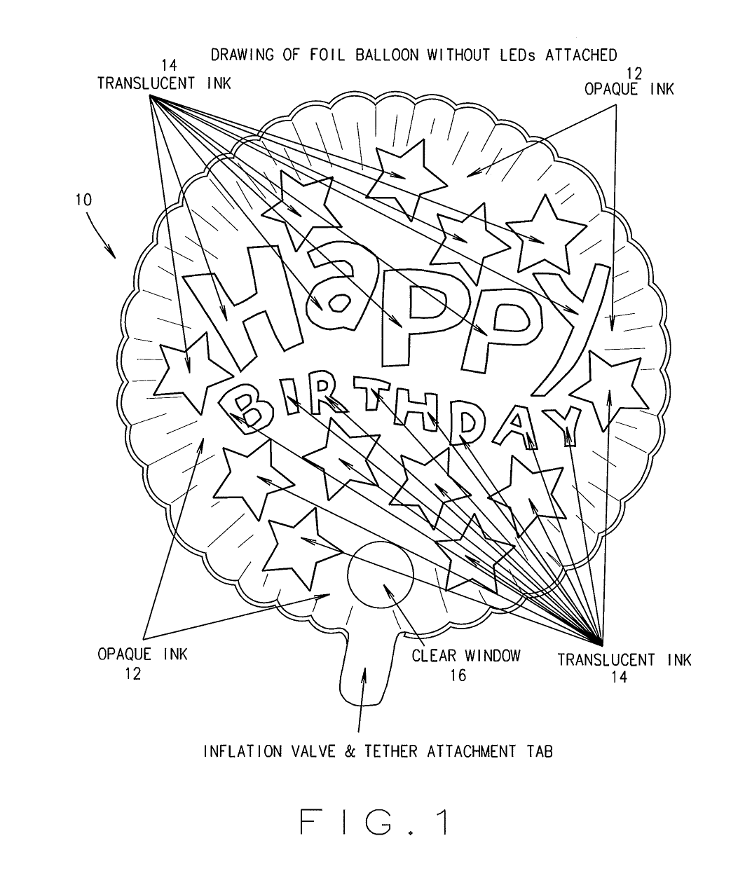

Referring to the drawings more particularly by reference numbers wherein like numerals refer to like parts, FIG. 1 illustrates one embodiment of the present illuminated foil balloon 10 showing a front elevational view of one side of the present balloon wherein both opaque inks 12 as well as translucent inks 14 have been used on the exterior surface of the balloon to create a design on the exterior surface thereof. More particularly, translucent inks 14 have been used to create graphics associated with the exterior portion of the balloon 10 whereas opaque inks 12 have been used in and around the translucent inks 14 to create the exterior background colors associated with the particular balloon 10. In this regard, any opaque material or ink can be used to create the opaque background areas of the balloon. Also, the opaque background areas of the balloon do not need to be completely opaque but should be considerably more opaque than the translucent graphics which are intended to be illuminated. In addition, the illuminated areas can be reversed in some or all areas of the balloon so that some or all of the opaque areas are translucent and some or all of the graphics are opaque.

A clear window 16 is formed on one side of the balloon 10 as illustrated in FIG. 1, the clear window 16 being positioned and located where the light source will be attached to the balloon 10 as will be hereinafter further explained. The clear window 16 extends between the exterior and interior surfaces of the balloon 10 and allows any light shining therethrough to enter into the interior space of the inflated balloon 10. As will be hereinafter explained, any light entering the interior space of balloon 10 through window 16 will exit through the graphic pattern and lettering created by the translucent inks 14.

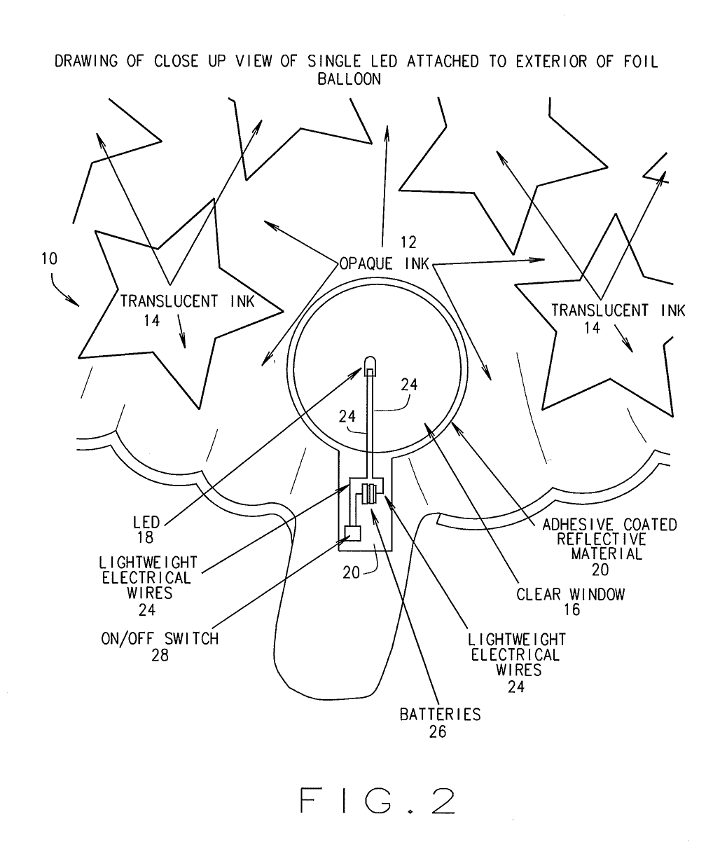

FIG. 2 illustrates one embodiment of the present invention wherein a single LED light source 18 is positioned over the clear window 16 on the exterior portion of balloon 10 as illustrated. The LED light source 18 is fixedly attached to one side of a reflective backing material 20 and the reflective material 20 is then attached to the exterior surface of balloon 10 using a suitable adhesive which is coated over the reflective material. The light source 18 is positioned and located between the reflective material 20 and the clear window 16 such that light emitting from light source 18 will be reflected off of material 20 and directed through window 16 to the interior space of the inflated balloon 10. As illustrated in FIG. 2, the single LED light source 18 is electrically coupled via conductive paths 24 to a battery pack 26 and an on/off switch 28 is likewise electrically coupled to both the light source 18 and the battery pack 20 for turning the light source on and off in a conventional manner. The battery pack 20 and the on/off switch 28 are likewise attached to the backing material 20.

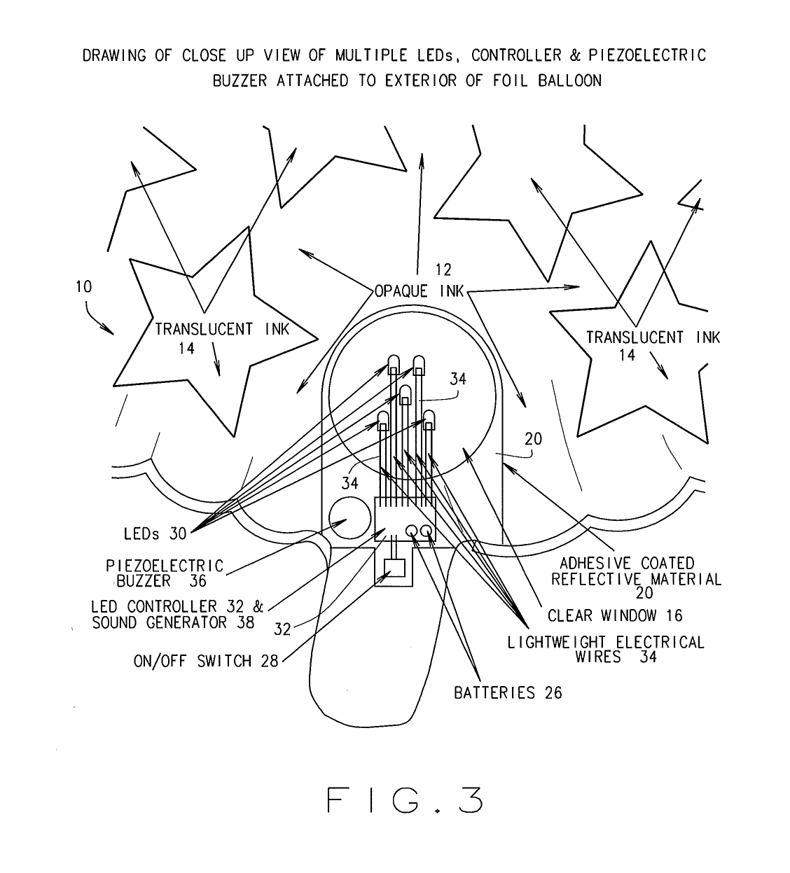

FIG. 3 is a partial front elevational view of another embodiment 10′ of the present invention wherein a plurality of LED lights 30 are positioned and located over the clear window 16, the LED lights 30 being attached to the exterior portion of inflated balloon 10′ in a similar manner as explained with respect to FIG. 2. Similar to light source 18, the plurality of lights 30 are attached to the exterior portion of inflated balloon 10′ through the use of a similar adhesively coated reflective material 20. In this particular embodiment, the battery pack 26 is incorporated into a microprocessor or controller 32 and the plurality of LED lights 30 are electrically connected to the controller 32 in a conventional manner such as through conductive paths 34. The controller 32 is programmed so as to cause the LED lights 30 to blink or flash independently of each other in a sequence programmed into controller 32. This blinking pattern produces a unique illuminated balloon as the blinking lights 34 bounce off of the interior surface of inflated balloon 10′ and exit through the pattern and graphics formed by translucent inks 14. It is also recognized and anticipated that the plurality of LED lights 30 can include a wide variety of multiple colored LED lights such that the lighting effect will be multi-colored. As previously explained, light entering through clear window 16 into the interior space of inflated balloon 10′ is reflected by the reflective backing material (not shown) associated with the interior surface of the inflated balloon 10′ until such light is allowed to escape through the translucent ink at which point the lettering and graphics formed by the translucent ink 14 become illuminated. In this regard, it is recognized and anticipated that any suitable type of reflective material can be utilized on the interior walls of the inflatable balloon 10′ to create a light stencil to control where light is allowed to exit the balloon depending upon the type of materials used for the balloon 10′. For example, any reflective materials such as foil, white film or reflective ink can be used to reflect light around the interior space of the balloon but metal foil is generally referred because it is very effective in illuminating the interior of the balloon. In this regard, it is recognized that the interior reflective material would not cover the translucent ink portions associated with the exterior face of the balloon 10′.

The embodiment of FIG. 3 also includes a piezoelectric buzzer 36 and a sound generator 38 which are configured in a conventional manner and coupled to controller 32 so as to produce musical sounds coming out of the piezoelectric buzzer 36. It is also well-known in the art to synchronize the flashing LED lights 30 to the musical sounds generated by the sound generator 38 and coming out of the piezoelectric buzzer 36 through well-known circuitry and sequences such as the LED color organ schematics available on the internet and on You Tube at https://www.youtube.com/watch?v=ubQC839Pvqk. The circuitry can be incorporated into the controller 32 and the LED lights 30 can be synchronized with the musical sounds coming out of the piezoelectric buzzer 36 to further enhance the lighting effect. The on/off switch 28 can likewise be incorporated into the controller 38 in a conventional manner such that the switch 28 can activate and deactivate power to the LED lights, the controller and the other components illustrated in FIG. 3.

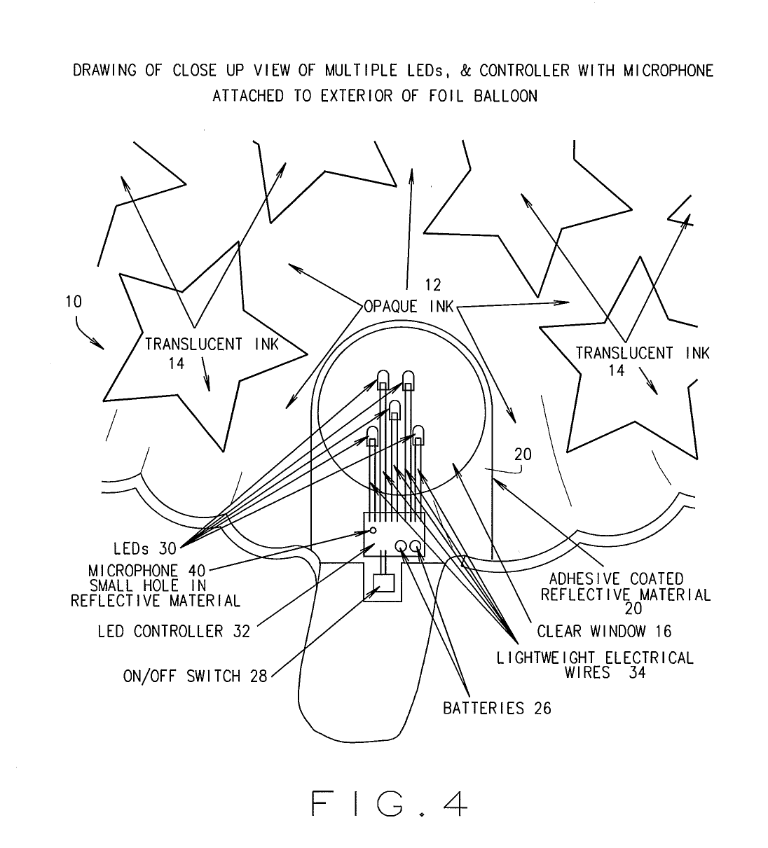

FIG. 4 represents still another embodiment 10″ of the present invention wherein the piezoelectric buzzer 36 and sound generator 38 associated with the embodiment disclosed in FIG. 3 have been removed from the circuitry and a small microphone 40 has been added to the controller 32 as illustrated in FIG. 4. In all other respects, the operation of the embodiment 10″ illustrated in FIG. 4 is substantially identical to the operation of the elements disclosed in FIG. 3 including the plurality of LED lights 30, controller 32 and on/off switch 28. In the embodiment disclosed in FIG. 4, the controller 32 is programmed in conjunction with microphone 40 and known synchronizing circuitry so as to synchronize the blinking or flashing of the LED lights 30 with music received by the microphone 40 from an external sound source. Again, synchronizing circuitry and sequencing of the light source 30 with music received by microphone 40 can be accomplished in a conventional manner.

Although LED lights are preferred since they are small, lightweight, long lasting and energy efficient, it is recognized and anticipated that any light source can be used for light sources 18 and 30 disclosed herein. It is also recognized and anticipated that a plurality of different types of translucent inks can likewise be used to create the lettering, design and graphics printed on the outside of the inflatable balloon 10′ and 10″ and that any suitable reflective material 20 can likewise be utilized in association with the light source 18 and 30.

In addition, the various embodiments of the present invention may likewise have applicability for use with balloons made of other materials. Although foil balloons are preferred, it is recognized and anticipated that the various embodiments of the present invention may also be adaptable for use with balloons made of latex and/or Mylar® type materials. Still further, the batteries 26 associated with the various embodiments of the present invention can be any suitable single battery or plurality of batteries having sufficient voltage for driving the electronics associated with the various embodiments.

From the foregoing, it will be seen that the various embodiments of the present invention are well adapted to obtain all of the objectives and advantages set forth above together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Thus, there has been shown and described several embodiments of a novel illuminated balloon. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. In addition, use of the terms “coupled to” or “coupled with” in the foregoing specification and subsequent claims are intended to mean that other members, components, and/or mechanisms may lie between the two members that are “coupled together”, and direct attachment, connection or mating of the two members is not required.

It is also recognized and anticipated that the graphics associated with the exterior of the balloon could be just lettering, just numbers, just a pattern or design, or any combination of letters, numbers and/or a pattern or design. Use of the term “graphics” in the foregoing specification and subsequent claims is intended to mean either letters by themselves, numbers by themselves, a pattern or design by itself, or any combination of letter(s), number(s) and/or a pattern or design.

Many changes, modifications, variations and other uses and applications of the present constructions will, however, become apparent to those skilled in the art after considering this specification and the accompanying drawings. All such drawings, modifications, variations and other uses and applications which do not depart from the spirit and scope of the invention are deemed to be covered by the invention which is limited only by the claims which follow.

What is claimed:

1. An illuminated inflatable balloon assembly comprising:
a balloon having interior and exterior surfaces;
a clear window associated with said balloon, said window extending between the interior and exterior surfaces of said balloon;
graphics associated with the exterior surface of said balloon, said graphics being created with translucent ink;
a light source attached to a reflective material, said light source being further attached to the exterior surface of said balloon over said clear window such that said light source is located between said reflective material and said window;
a power source coupled to said light source;
a controller coupled to said light source and to said power source for causing said light source to repeatedly flash so long as power is supplied to said light source; and
an on/off switch coupled to said power source for controlling power to said light source.

2. The illuminated inflatable balloon assembly of claim 1 including a sound generator and a piezoelectric buzzer coupled to said controller for generating musical sounds from said piezoelectric buzzer, said controller being programmed to synchronize the flashing of said light source to the musical sounds coming out of said piezoelectric buzzer.

3. The illuminated inflatable balloon assembly of claim 1 including a microphone coupled to said controller, said controller being programmed to synchronize the flashing of said light source to music received by said microphone from an external sound source.

4. The illuminated inflatable balloon assembly of claim 1 wherein said light source includes a plurality of LED lights.

5. The illuminated inflatable balloon assembly of claim 4 wherein said plurality of LED lights include multi-colored lights.

6. The illuminated inflatable balloon assembly of claim 1 wherein said power source, said controller and said on/off switch are attached to the exterior surface of said balloon.

7. The illuminated inflatable balloon assembly of claim 1 wherein the interior surface of said balloon includes a reflective backing material.

8. The illuminated inflatable balloon assembly of claim 1 wherein said balloon is a foil balloon.

9. The illuminated inflatable balloon assembly of claim 1 wherein the exterior surface of said balloon includes opaque ink in areas surrounding the graphics associated therewith.

10. An illuminated inflatable balloon assembly comprising:
a balloon having interior and exterior surfaces;
a clear window associated with said balloon;
a light source attached to a reflective material, said light source being further attached to the exterior surface of said balloon over said clear window such that said light source is positioned and located between said reflective material and said window;
graphics associated with the exterior surface of said balloon, said graphics being created with translucent ink;
the exterior surface of said balloon further including opaque areas surrounding the graphics created with said translucent ink;
a power source coupled to said light source;
a controller coupled to said light source and to said power source for controlling the illumination of said light source;
a sound generator and a piezoelectric buzzer coupled to said controller, said sound generator and said piezoelectric buzzer generating musical sounds through said piezoelectric buzzer;
said controller being programmed to synchronize the illumination of said light source to the musical sounds coming out of the piezoelectric buzzer; and
an on/off switch coupled to said power source for controlling power to said light source and to said controller.

11. The illuminated inflatable balloon assembly of claim 10 wherein said light source includes a plurality of LED lights.

12. The illuminated inflatable balloon assembly of claim 10 wherein said power source, said controller, said sound generator, said piezoelectric buzzer and said on/off switch are attached to the exterior surface of said balloon.

13. The illuminated inflatable balloon assembly of claim 10 wherein said opaque areas are formed with opaque ink.

14. The illuminated inflatable balloon assembly of claim 10 wherein at least a portion of the interior surface of said balloon includes a reflective material.

15. An illuminated inflatable balloon assembly comprising:
a balloon having interior and exterior surfaces;
a clear window associated with said balloon;
a reflective material associated with the interior surface of said balloon;
graphics associated with the exterior surface of said balloon, said graphics being translucent;
the exterior surface of said balloon further including opaque areas surrounding said graphics;
a light source attached to a reflective material, said light source being further attached to the exterior surface of said balloon over said clear window such that said light source; is positioned and located between said reflective material and said clear window;
a power source coupled to said light source;
a controller coupled to said light source and to said power source for controlling the illumination of said light source when power is supplied thereto;
a microphone coupled to said controller, said microphone being capable of receiving music from an external sound source;
said controller being programmed to synchronize the illumination of said light source to the music received by said microphone from an external sound source; and
an on/off switch coupled to said power source for providing power to said light source and to said controller.

16. The illuminated inflatable balloon assembly of claim 15 wherein said light source includes a plurality of LED lights.

17. The illuminated inflatable balloon assembly of claim 16 wherein said plurality of LED lights include multi-colored lights.

18. The illuminated inflatable balloon assembly of claim 15 wherein said power source, said controller, said microphone, and said on/off switch are attached to the exterior surface of said balloon.
